(19) United States
(12) Patent Application Publication
(10) Pub. No.: US 2023/0345977 A1
(43) Pub. Date: Nov. 2, 2023

(54) EQUILIBRATION AND COOLING CONVEYOR SYSTEM

(71) Applicant: J.C. Ford Company, La Habra, CA (US)

(72) Inventors: Scott D. Ruhe, Yorba Linda, CA (US); Manuel Maldonado, Montclair, CA (US)

(21) Appl. No.: 18/194,487

(22) Filed: Mar. 31, 2023

Related U.S. Application Data
(60) Provisional application No. 63/362,287, filed on Mar. 31, 2022.

(51) Int. Cl. A23L 3/36; F25D 13/06

(52) U.S. Cl. CPC A23L 3/361; F25D 13/06

(57) ABSTRACT

A conveyor system can include a first side member and a second side member, a top conveyor portion, a middle conveyor portion and a bottom conveyor portion. The top conveyor portion can extend along an inclined section and a horizontal section and can include a top conveyor belt driven by a top motor and supported by a top return roller. The middle conveyor portion can be positioned below the top conveyor portion and can include a middle conveyor belt driven by a middle motor and supported by a middle return roller. The bottom conveyor portion can be positioned below the middle conveyor portion and can include a bottom conveyor belt driven by a bottom motor and supported by a bottom return roller.

### PRIORITY INFORMATION

Any and all applications for which a foreign or domestic priority claim is identified in the Application Data Sheet as filed with the present application are hereby incorporated by reference under 37 C.F.R. § 1.57.

This application claims the benefit of U.S. Provisional Patent Application No. 63/362,287, filed Mar. 31, 2022, the entire contents of which is hereby incorporated by reference in its entirety.

### BACKGROUND

### Field

The disclosure relates to methods, systems, and devices for cooling and equilibrating products on a conveyor system.

### Related Art

After food products are removed from an oven, the food products often undergo a series of cooling or equilibrating procedures to reduce the food product temperature before it can be packaged or undergo further processes. Current methods of cooling food products involve placing the food products on a series of conveyor belts. Often, the products must be elevated using a separate inclined conveyor belt to reach the first cooling conveyor belt system.

### SUMMARY

Various systems, methods, and devices are disclosed for providing cooling and equilibration to food products using a single conveyor system. The systems, methods, and devices of the disclosure each have several innovative aspects, no single one of which is solely responsible for the desirable attributes disclosed herein.

Many conveyor systems for cooling use a series of conveyor systems including a stacked conveyor system and a separate inclined conveyor belt or “boom”. The boom elevates food product to a height greater than the top belt of the stacked conveyor system and a transfer member is used to transfer the food product from the boom to the stacked conveyor system. However, transferring food product between the boom and stacked conveyor system can result in food waste during the transfer process. Additionally, the multiple systems take up a significant amount of space in a manufacturing facility because they must be spaced a distance from each other to utilize the transfer member and because the area under the boom is wasted space (e.g., does not provide cooling benefits).

Combining the boom and the stacked conveyor system such that a top conveyor belt spans both the inclined portion of the boom and the horizontal portion of the stacked conveyor system can provided improved space management, improved cooling, and reduce the risk of wasted food product. Because top conveyor belt spans both the inclined portion and the horizontal portion, there is no need for a transfer member between the inclined portion and the horizontal portion, reducing the risk of wasted food product associated with transfers between systems. Additionally, no gap is present between the inclined portion and the horizontal portion, reducing the space required by the system. Further, the lower layers of the stacked conveyor system can extend beneath the inclined portion, utilizing the otherwise wasted space beneath the inclined portion.

Thus, in accordance with some embodiments, a conveyor system can comprise a support frame comprising a first side member and a second side member. The first side member and the second side member can be supported by the plurality of legs. The first and second side members can include an inclined section and a horizontal section. The conveyor system can include one or more conveyor portions driven by one or more motors. For example, the conveyor system can include a top conveyor portion extending along the inclined section and the horizontal section. The top conveyor portion can include a top conveyor belt supported by a top return roller. The top return roller can extend between the first side member and the second side member. The top conveyor portion can be driven by a top motor. The conveyor system can include a middle conveyor portion positioned below the top conveyor portion. The middle conveyor portion can include a middle conveyor belt supported by a middle return roller. The middle return roller can extend between the first side member and the second side member. The middle conveyor portion can be driven by a middle motor. The conveyor system can include a bottom conveyor portion positioned below the middle conveyor portion. The bottom conveyor portion can include a bottom conveyor belt supported by a bottom return roller. The bottom return roller can extend between the first side member and the second side member. The bottom conveyor portion can be driven by a bottom motor. The conveyor systems can include one or more conveyor belts that are configured to travel in different directions. For example, the top conveyor belt and the bottom conveyor belt can be configured to travel in a first direction and the middle conveyor belt can be configured to travel in a second direction, the first direction opposite the second direction.

The conveyor systems described herein can transfer food product between different conveyor belts. For example, the conveyor system can include a first transfer member configured to transport food product from the top conveyor belt to the middle conveyor belt. The conveyor system can include a second transfer member configured to transport food product from the middle conveyor belt to the bottom conveyor belt. At least one of the transfer members can optionally reject food product from the conveyor system. For example, any of the transfer members can be configured to move between a first configuration and a second configuration, wherein in the first configuration, the second transfer member is configured to transport food product between conveyor belts, and wherein in the second configuration, the second transfer member is configured to allow food product to be rejected from the conveyor system. In some examples, a transfer motor is configured to move the second transfer member from the first configuration to the second configuration.

The speed of the one or more conveyor belts can be controlled. The conveyor belts may travel at the same or different speeds. For example, the top conveyor belt can be configured to travel at a first speed, the middle conveyor belt can be configured to travel at a second speed, and the bottom conveyor belt can be configured to travel at a third speed in use. For example, the second speed can be greater than the first speed and the third speed can be greater than the second speed. At least one of the first side member and the second side member can include one or more side openings. The conveyor belts can comprise any suitable structure. For example, the top conveyor belt, the middle conveyor belt, and the bottom conveyor belt can comprise a mesh structure with a plurality of openings. The speed of at least one of the motors, for example, the top motor, the middle motor, or the bottom motor can be configured to run at variable speeds. The lower conveyor portions can extend underneath an inclined portion of the top conveyor portion. For example, at least one of the middle conveyor portion or the bottom conveyor portion can extend below an inclined portion of the top conveyor portion. The conveyor system described herein can include additional conveyor portions positioned between the top conveyor portion and the bottom conveyor portion. For example, the conveyor system can comprise a plurality of conveyor portions positioned below the middle conveyor portion. Each conveyor portion of the plurality of conveyor portions can comprise a conveyor belt that can be supported by a return roller extending between the first side member and the second side member.

In additional embodiments, a conveyor system can comprise a first side member and a second side member. The first and second side members can be supported by a plurality of leg. The first and second side members can include an inclined section and a horizontal section. The conveyor system can include one or more conveyor portions driven by one or more motors. For example, the conveyor system can include a first conveyor portion that includes a first conveyor belt supported by a first return roller. The first return roller can extend between the first side member and the second side member. The first conveyor portion can be driven by a first motor assembly. The conveyor system can include a second conveyor portion positioned below the first conveyor portion. The second conveyor portion can include a second conveyor belt supported by a second return roller. The second return roller can extend between the first side member and the second side member. The second conveyor portion can be driven by a second motor assembly, where the second motor assembly can extend between the first side member and the second side member in the inclined section. In this arrangement, a portion of the second conveyor belt extends into the inclined section. The conveyor system can include a third conveyor portion positioned below the second conveyor portion. The third conveyor portion can include a third conveyor belt, which can be supported by a third return roller. The third return roller can extend between the first side member and the second side member. The third conveyor portion can be driven by a third motor assembly, where the third motor assembly can extend between the first side member and the second side member in the inclined section. In this arrangement, a portion of the third conveyor belt extends into the inclined section.

The conveyor system described herein can include one or more conveyor belts that are configured to travel in different directions. For example, the first conveyor belt and the third conveyor belt are configured to travel in a first direction and the second conveyor belt is configured to travel in a second direction, the first direction opposite the second direction. In some examples, at least one of the first side member and the second side member includes one or more side openings. The conveyor system described herein can transfer food product between different conveyor belts. For example, the conveyor system can include one or more transfer members, such as a first transfer member and a second transfer member. The first transfer member can be configured to transport food product from the first conveyor belt to the second conveyor belt and the second transfer member can be configured to transport food product from the second conveyor belt to the third conveyor belt.

In yet additional embodiments, a conveyor system can comprise a support frame comprising a first side member and a second side member. The first side member and the second side member can be supported by the plurality of legs. The first side member and/or the second side member can include one or more side openings. The conveyor system can include a plurality of conveyor portions. For example, the conveyor system can include a first conveyor portion that includes a first conveyor belt. The first conveyor belt can extend between a first return roller and a first motor assembly. The first return roller and the first motor assembly can extend between the first side member and the second side member. The conveyor system can include second conveyor portion that includes a second conveyor belt. The second conveyor belt can extend between a second return roller and a second motor assembly. The second return roller and the second motor assembly can extend between the first side member and the second side member. The conveyor system can include a third conveyor portion that includes a third conveyor belt. The third conveyor belt can extend between a third return roller and a third motor assembly. The third return roller and the third motor assembly can extend between the first side member and the second side member. The conveyor system can transfer food product between the different conveyor belts. For example, the conveyor system can include a transfer member that can extend between the first side member and the second side member. The transfer member can rotate between different configurations. For example, the transfer member can be configured to transfer food product from the second conveyor belt to the third conveyor belt when in a closed configuration and the transfer member can be configured to rotate to an open configuration. In the open configuration, food product is ejected from the conveyor system.

The conveyor systems described herein can include one or more conveyor belts that are configured to travel in different directions. For example, the first conveyor belt and the third conveyor belt are configured to travel in a first direction and the second conveyor belt is configured to travel in a second direction, where the first direction is opposite the second direction. The conveyor system can include a transfer motor, that can be configured to move the transfer member from the closed configuration to the open configuration and vice-versa.

### BRIEF DESCRIPTION OF THE DRAWINGS

Various embodiments are depicted in the accompanying drawings for illustrative purposes and should in no way be interpreted as limiting the scope of the embodiments. Furthermore, various features of different disclosed embodiments can be combined to form additional embodiments, which are part of this disclosure.

FIG. 1 illustrates a front and right-side perspective view of an embodiment of a conveyor system.

FIG. 2 illustrates a back right-side perspective view of the conveyor system of FIG. 1.

FIG. 3 illustrates right-side view of the conveyor system of FIG. 1.

FIG. 4 illustrates a top, front, and right-side perspective view of an embodiment of a conveyor system.

FIG. 5 illustrates a top, back, and right-side perspective view of the embodiment of FIG. 4 with certain components removed.

FIG. 6 illustrates a left-side view of the embodiment of FIG. 4.

FIG. 7 illustrates a right-side view of the embodiment of FIG. 4.

FIG. 8 illustrates a right-side view of the embodiment of FIG. 4 with certain components removed.

FIG. 9 illustrates a right-side view of the embodiment of FIG. 4 with certain components removed.

FIG. 10 illustrates a partial section view of the embodiment of FIG. 4 with a transfer member in a closed configuration.

FIG. 11 illustrates a partial section view of the embodiment of FIG. 4 with a transfer member in an open configuration.

FIG. 12 illustrates an isolation view of an embodiment of a transfer member in a closed configuration.

FIG. 13 illustrates an isolation view of embodiment of FIG. 12 in an open configuration.

FIG. 14A illustrates a first perspective view of an embodiment of a motor assembly.

FIG. 14B illustrates a second perspective view of the embodiment of FIG. 14B.

FIG. 15A illustrates a first perspective view of an embodiment of an end roller assembly.

FIG. 15B illustrates a second perspective view of the embodiment of FIG. 15A.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Although the various embodiments disclosed herein may have specific relevance to food product production, the features, advantages, and other characteristics disclosed herein may have direct or indirect applicability to other applications, such as, for example, in other manufacturing applications that require cooling product, other mechanical devices, and/or the like.

### Overview

During the production of products, such as, for example, food products, there is often a baking process prior to packaging or further processing. Following the baking process, the products generally must be cooled or equilibrated before they can be packaged or further processed. Cooling, as the term is used herein, may refer to the overall reduction in temperature of a product. Equilibration, as the term is used herein, may refer to the temperature stabilization of a product, desirability resulting in even temperature and/or moisture distribution of a food product. Generally, throughout the disclosure, the terms “cooling” and “equilibrating” may be used interchangeability, as the systems disclosed herein may be capable of performing both product cooling and product equilibration. For example, a product may exit an oven at a temperature of, for example, 200 degrees Fahrenheit, and may need to be cooled to a temperature of, for example, 100, 80, 60, and/or the like degrees Fahrenheit before it can be packaged. It is recognized that the foregoing temperatures are given as examples only and products exiting an oven may start at any normal temperature and be cooled to any desired temperature using the systems disclosed herein. One method of cooling products is to place the products on a conveyor system involving one or more conveyor belts and allow the products to gradually cool during their travel on the system. Sometimes, the cooling system may be in a room with a cooling system, such as, for example, a refrigerated room, or there may be a series of fans around the cooling system to accelerate the cooling process.

In order to maximize floor space in, for example, a production facility, stacked conveyor systems may be used for cooling. Because the products often exit an oven near floor level, the products must be raised using, for example, an inclined conveyor belt, to reach the top conveyor belt in the conveyor series. The space under the incline conveyor is generally considered wasted space and is not maximized for the cooling process. Depending on the scale of the cooling system, the wasted space can be detrimental to maximizing production facility resources. For example, if a conveyor system used for cooling is between, for example, 100 to 140 feet long, the system may require an incline conveyor of, for example, 20 to 30 feet. This space could be put to better use.

### Conveyor Systems

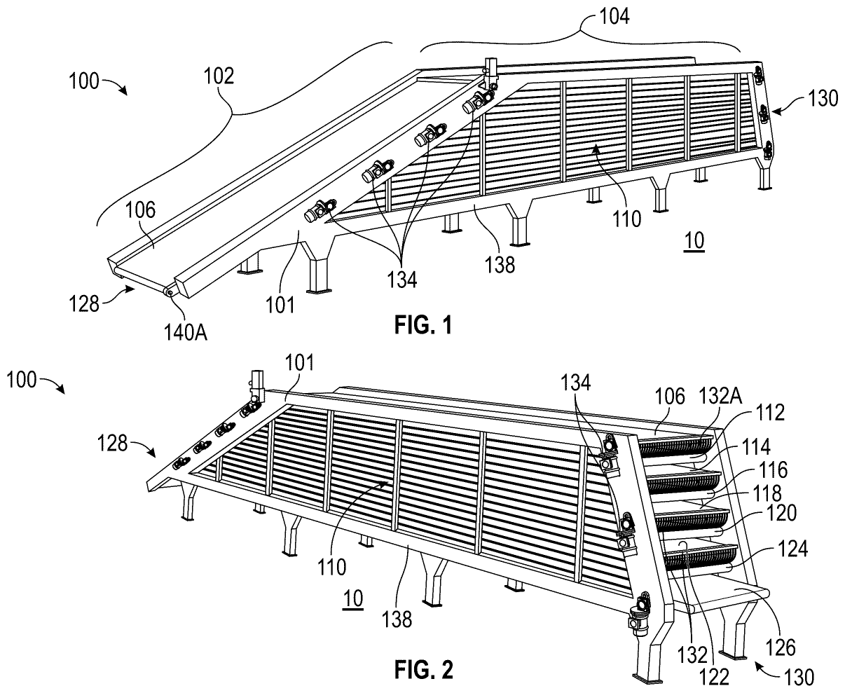

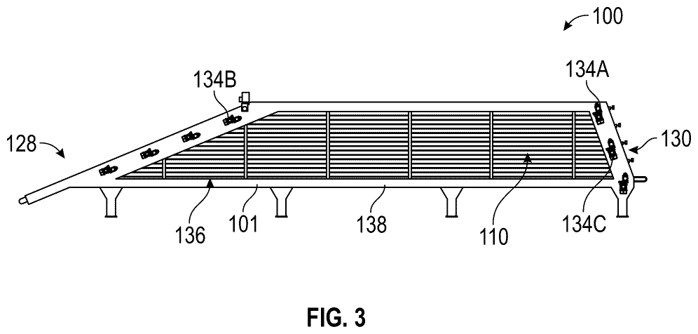

FIG. 1 illustrates a front and right-side perspective view of an embodiment of a conveyor system 100. FIG. 2 illustrates a back right-side perspective view of the conveyor system 100. FIG. 3 illustrates a right-side view of the conveyor system 100. The conveyor system 100 may be used to cool products, such as, for example food products, prior to the products undergoing further processing. The conveyor system 100 may operate in a room of approximately ambient temperature or may operate in a room with one or more cooling systems. After the products exit the heating process, for example, an oven, the product may be placed on the incline portion 102 of a top conveyor belt 106 of the conveyor system 100 and raised along the top conveyor belt to a horizontal portion 104 of the top conveyor belt 106. The conveyor system 100 may include a frame 101 and multiple stacked conveyor belts 110, which may be configured to cool the product in series. For example, a product may travel along the top conveyor belt 106 in a first direction (e.g., from left to right in FIG. 3) before being transferred to a second conveyor belt 112 underneath the top conveyor belt, where the product continues to travel in a second direction opposite to the first direction (e.g., from right to left in FIG. 3). Next, the product may be transferred to a third conveyor belt 114 underneath the second conveyor belt 112 and continue to travel in the first direction. This process can continue with any number of stacked conveyor belt systems, such as, for example, 2, 3, 4, 5, 6, 7, 8, 9, 10, 15, 25, 35, 45, and/or the like depending on a multitude of factors such as, for example, the amount of space available in the facility, the time required for cooling, the weight of the products and conveyor systems, and/or the like. For example, in the embodiment illustrated in FIG. 1-3, the conveyor system 100 includes nine conveyor belts, including the top conveyor belt 106, the second conveyor belt 112, the third conveyor belt 114, a fourth conveyor belt 116, a fifth conveyor belt 118, a sixth conveyor belt 120, a seventh conveyor belt 122, an eighth conveyor belt 124, and a bottom most ninth conveyor belt 126. It is recognized that the system will generally contain an uneven number of stacked conveyor belt systems so that a product can enter the conveyor system 100 at one end (e.g., front end 128) and exit at an opposite end (e.g., back end 130). As shown in FIG. 1, the stacked or tiered conveyor systems 110 generally increase in length moving from the horizontal portion of the top conveyor belt 106 to the bottom most conveyor belt 126. Each tier in the conveyor system 100 is configured to extend underneath the inclined portion 102 of the top conveyor belt 106 in order to utilize the space under the inclined portion of the top conveyor belt 106. For example, the horizontal portion 104 of the top conveyor belt 106 may be 100 feet long and receive a product from an oven via the incline portion 102. The product may travel along both the incline portion 102 and the horizontal portion 104 of the top conveyor belt 106 prior to transferring the product to the second conveyor belt 112, which may be, for example 105 feet long, and extending approximately 5 feet under the inclined portion 102 of the top conveyor belt 106. Similarly, the third conveyor belt 114 may be, for example, 110 feet long, and extend approximately 10 feet under the inclined portion 102 of the top conveyor belt 106. It is recognized that the length of the conveyor belts 110 and the amount of extension under the inclined portion 102 of the top conveyor belt 106 are system dependent and the foregoing dimensions are provided for example only. The amount of extension of the tiered conveyor belts 110 may be dependent on the degree of incline and length of the inclined portion 102 of the top conveyor belt 106 as well as a multitude of other factors.

As shown in FIG. 2, to facilitate the transfer of products between the multiple tiers 110 in the conveyor system 100, the system may use gravity and transfer devices 132, such as for example, curved rods, to transfer the products from, for example, the top conveyor belt 106 to the second conveyor belt 112. For example, the transfer devices 132 may comprise a plurality of curved rods that are mounted to the frame 101 of the conveyor system 100. The curved rods 132 may be curved in a direction towards and in the same direction of travel as the receiving conveyor belt. The curved rods 132 may be metal, plastic, and/or the like. For example, a product traveling and cooling along the top conveyor belt 106 may travel in the first direction until reaching the end of the belt and contact a first transfer device 132A which, using gravity, transfers the product to the second conveyor belt 112 to continue the cooling process in the second direction. The transfer device 132 may provide an additional benefit of rotating or flipping the product during each transfer between tiers 110 to further accelerate the cooling process. Similarly, once the product reaches the end of the second conveyor belt 112, there may be an additional transfer device 132 (not shown) that transfers the product onto the third conveyor belt 114 to continue cooling in the first direction. In a multi-tiered system, every odd numbered or alternating conveyor belt (e.g., top conveyor belt 106, third conveyor belt 114, fifth conveyor belt 118, etc.) may have the transfer device 132 on the same side (e.g., the back end 130), wherein every even numbered or alternating conveyor belt (e.g., second conveyor belt 112, fourth conveyor belt 116, sixth conveyor belt 120, etc.) may have the transfer device 132 on the opposite side (e.g., closer to the front end 128). In this manner, the product is continually changing direction between tiers 110 and may also be rotated between tiers 110. The transfer devices 132 positioned under the inclined portion 102 of the top conveyor belt 106 may be the same or different as the transfer devices 132 positioned on the back end 130 of the conveyor system 100. As the product continues between tiers 110, the product's height relative to the ground 10 is continually decreased.

In some embodiments, the transfer devices 132 may be removable from the conveyor system 100. In some embodiments, the transfer devices 132 may be rotatable such that an operator could rotate the transfer device to gain better access to the belts 110 and/or the products on the belts 110. The transfer devices 132 may include a lever or other device to facilitate rotation. Rotatable or removable transfer devices 132 may provide the advantage on enabling easier access to the conveyor system 100 to fix or mitigate problems that arise, such as, for example, a stuck or jammed product. An additional advantage may be to facilitate easier cleaning of the transfer devices 132 and/or the conveyor system 100.

In some embodiments, the conveyor belts 110 in the conveyor system 100 may be generally rectangular. In some embodiments, individual motors 134 may be used for each conveyor belt 110 in the conveyor system 100. For example, the individual motors may be coupled to the frame 101 at one end of each conveyor belt 110. Each motor 134 may comprise a drive shaft (not shown) configured to drive each conveyor belt 110. For example, the top conveyor belt 106 may be driven by a first motor 134A (see e.g., FIG. 3), the second conveyor belt 112 may be driven by a second motor 134B (see e.g., FIG. 3), the third conveyor belt 114 may be driven by a third motor 134C (see e.g., FIG. 3), and so forth. In the example of top conveyor belt 106, the first motor 134A is positioned at one end of the top conveyor belt 106 near the back end 130 of the conveyor system 100 and supported by the drive shaft of first motor 134A. The opposite end of the top conveyor belt 106 is supported by a roller 140A. Each conveyor belt 110 of the conveyor system 100 may extend between the drive shaft of their motor 134 and a roller, similar to the roller 140A. Like the motors 134, the rollers may extend between the left and right sides of the frame 101. In other embodiments, one or more belts 110 may be controlled by the same motor 134. Examples of individual motors 134 for each belt can be seen in FIGS. 1-3. Using individual motors 134 for each belt 110 may provide the advantage of allowing the conveyor belts 110 in the conveyor system 100 to be placed at different locations. For example, as shown in FIGS. 1 and 2, each belt of the tiers 110 ends at a separate location as the belts extend further under the inclined portion 102 of the top conveyor belt 106, which may be made easier by each belt having their own motor 134. In this way, the space under the inclined portion 102 of the top conveyor belt 106 can be maximized for cooling. As shown in FIGS. 1-3, each motor 134 may be placed on a side opposite the motors 134 above and below it. For example, the first motor 134A for the top conveyor belt 106 may be closer to the back end 130, the second motor 134B for the second conveyor belt 112 may be closer to the front end 128, the third motor 134C for the third conveyor belt 114 may be closer to the back end 130, and so forth. In other embodiments, one or more of the motors 134 may be on the same side as the tier 110 above and/or below it. In some embodiments, the inclined portion 102 of the top conveyor belt 106 may be configured as a separate component from the tiered conveyor belts 110 of the conveyor system 100. In other embodiments, including the examples illustrated herein, inclined portion 102 and the horizontal portion 104 are part of the continuous top conveyor belt 106 in the same conveyor system 100. Because individual motors 134 are used, in some embodiments, the motors 134 may be smaller than those used in a traditional tiered conveyor system.

As shown in FIG. 2, the back end 130 in the conveyor system 100 may be oriented at an oblique angle. An oblique angle back end 130 may allow for the conveyor belts 110 to extend out from underneath the top conveyor belt 106, such that the length of the conveyor belts 110 is greater than the length of the horizontal portion 104 of the top conveyor belt 106. For example, the length of the conveyor belts 110 moving from top to bottom may increase in length in the first direction in addition to increasing in length in the second direction under the inclined portion 102 of the top conveyor belt 106, where the first direction is left to right in FIG. 3 and the second direction is right to left in FIG. 3. Increasing in length in the first direction may provide benefits for the motor configurations. In other embodiments the system may have approximately a 90-degree angled back end 130 and the tiered conveyor belts 110 may not increase in length in the first direction moving from the top to the bottom of the conveyor system 100.

FIG. 3 illustrates an embodiment of a conveyor system 100 showing a right-side view of the system. As shown, the conveyor system 100 may generally include openings 136 in the side portions 138 between the tiers. In other embodiments, the sides 138 may be partially or completely closed. Having open sides 136 may provide cooling benefits such as, for example, allowing the products to readily transfer heat to the outside environment. Another benefit may be that open sides 136 allow additional cooling methods, such as, for example, fans to be used to accelerate the cooling process. For example, fans may be positioned outside of the conveyor system 100 and may blow air in the direction perpendicular or approximately perpendicular to the products directions of travel. In some embodiments, the conveyor system 100 may include a built-in cooling system, such as, for example, built-in fans. Open sides 136 may also provide cooling benefits if the room the conveyor system 100 is operating in is cooled. Open sides 136 may also provide the benefit of allowing moisture to escape the system, which may be desirable in the food processing industry.

Compared to traditional cooling systems, the conveyor system 100 may provide additional benefits as a result of the system being more open (e.g., including openings 136 in the sides 138). Additionally, the conveyor system 100 may be produced at a reduced cost if individual motors 134 are used rather than traditional serpentine motor drive systems. Individual motors 134 may provide an additional benefit of allowing each belt in the tiered system 110 to operate at a different speed. For example, the top conveyor belt 106 may operate at a first speed, the second conveyor belt 112 may operate at a second speed, the third conveyor belt 114 may operate at a third speed, and/or the like. Speed control may provide additional cooling benefits to the conveyor system 100. Additionally, because each tier 110 may be controlled by its own motor 134, the direction of travel may be changeable for each tier. For example, the conveyor system 100 may allow one of more tiers 110 to change direction using, for example, a control system, such that one or more tiers 110 may be able to operate in both directions of travel. Multi-directional tiers 110 may provide an advantage of, for example, allowing the system to reverse and/or reject certain products.

In some embodiments, the conveyor belts 110 in the conveyor system 100 may be generally horizontal or parallel to ground level. In other embodiments, one or move tiers 110 in the conveyor system 100 may be at an angle relative to the ground 110. In some embodiments, there may be more than one incline conveyor belts (similar to the inclined portion 102 of the top conveyor belt 106) such as, for example, where a product is raised multiple times during the cooling process. Individual motors 134 may provide the benefit of allowing some tiers 110 to have angles that are different than the other tiers 110. In some embodiments, the inclined portion 102 and the horizontal portion 104 of the top conveyor belt 106 may be separate conveyor belts driven by separate motors 134. In other embodiments, including the embodiment illustrated in FIG. 1-3, inclined portion 102 and the horizontal portion 104 comprise different portions of a single top conveyor belt 106 driven by the same motor 134A.

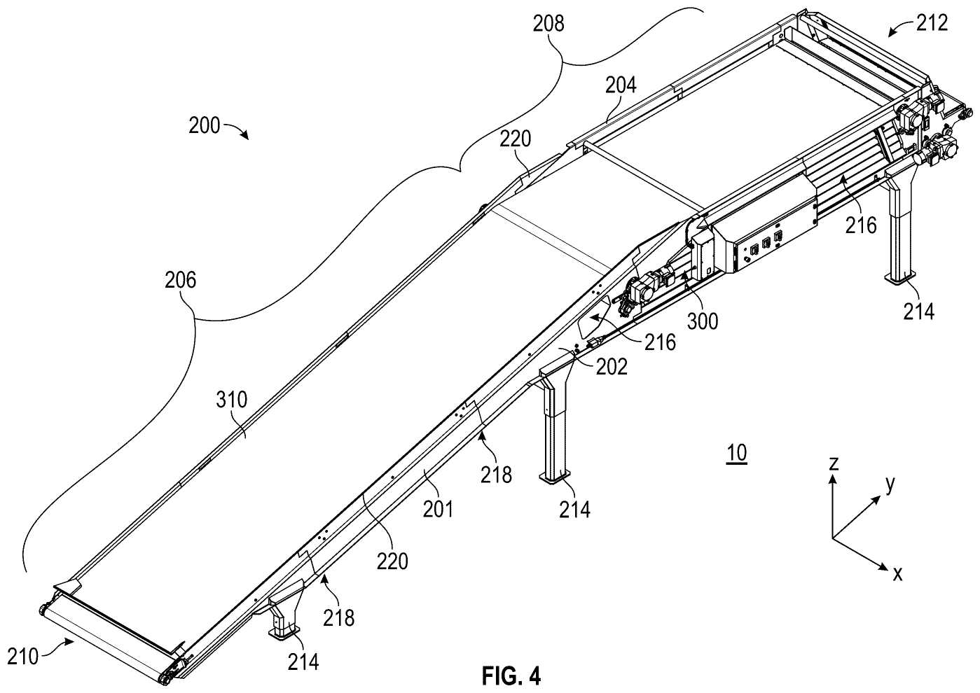

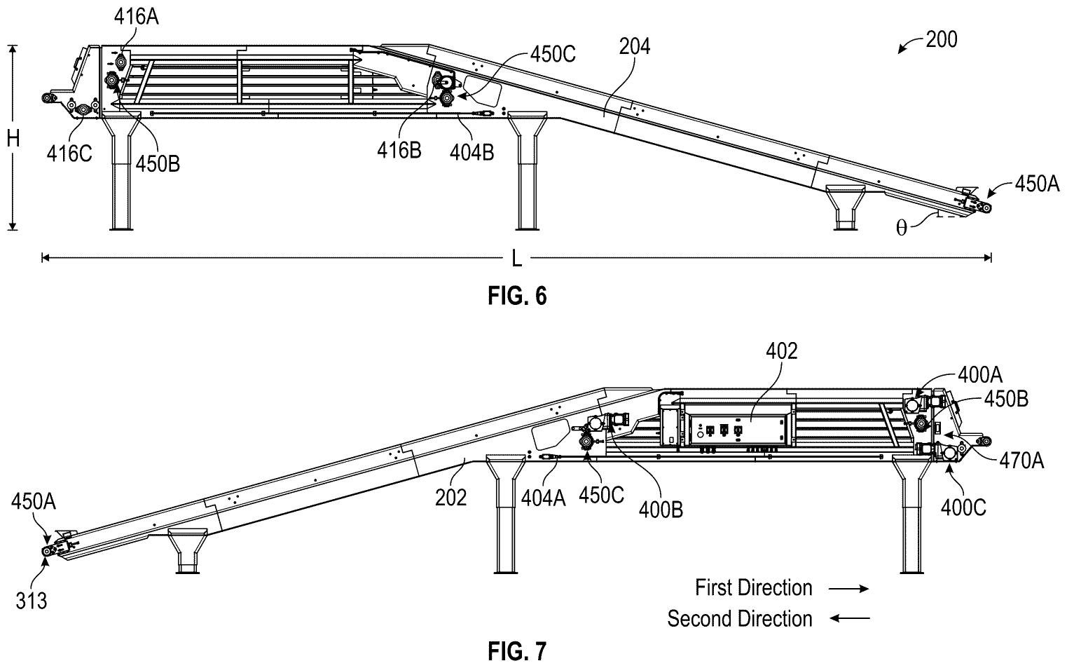

FIG. 4 illustrates a top, front, and right-side perspective view of an embodiment of a conveyor system 200. The conveyor system 200 may include any of the features of the conveyor system 100. The conveyor system 200 may comprise a support frame 201 and a plurality of conveyor portions 300. The support frame 201 may comprise a first side member 202 and a second side member 204. When the conveyor system 200 is viewed from a front end 210, the first side member 202 comprises a left side member and the second side member 204 comprises a right side member. The first side member 202 and second side member 204 may comprise an inclined section 206 and a horizontal section 208. For example, food product traveling on the inclined section 206 is generally traveling at an angle relative to the ground 10, while food product traveling on the horizontal section 208 is generally travelling at a zero angle or parallel to the ground. The inclined section 206 is inclined relative to the ground 10 at an angle theta (see e.g., FIG. 6). Generally, the angle theta is selected to minimize the length of the inclined section without being too large as to result in food product slipping backwards towards the front end 210. For example, the angle theta may be 5 degrees to 45 degrees (e.g., 5 degrees to 45 degrees, 10 degrees to 40 degrees, 15 degrees to 35 degrees, 20 degrees to 30 degrees, values between the foregoing, etc.).

The conveyor system 200 further comprises a front end 210 and a back end 212. The front end 210 may be considered the proximal end such that the back end 212 is distal to the front end 210. In normal operations, food product enters the conveyor system 200 via the front end 210, travels along the plurality of conveyor portions 300 until reaching the back end 212. Food entering the conveyor system 200 via the front end 210 is generally received from an oven discharge and is traveling along the conveyor portions 300 to be cooled or equalized. Once the food product reaches the back end 212, the food product may be discharged for further processing or packaging.

The conveyor system 200 may be supported by a plurality of legs 214. The plurality of legs 214 may be connected to the support frame 201. For example, the first side member 202 and the second side member 204 may each be coupled to a plurality of legs 214. As shown in FIG. 4, the length of each leg 214 may vary, depending on the position of the leg 214. For example, legs positioned near the front end 210 may be shorter than legs 214 positioned near the back end 212. Generally, all legs coupled to the support frame 201 in the horizontal section 208 are the same height. While the example conveyor system 200 is shown as having six legs 214, it is recognized that the conveyor system 200 can include any number of legs 214. For example, the conveyor system 200 may include 2, 4, 6, 8, 10, 12, 14, 16, 18, 20, and/or the like legs 214. Generally, the number of legs 214 is dependent on the size of the conveyor system 200, which may depend on the number of conveyor portions 300. For example, as described further herein, the conveyor system 200 can include any suitable number of conveyor portions 300. As the number of conveyor portions 300 increases, a height H of the horizontal section 208 generally also increases. Taller conveyor systems 200 (e.g., with greater height H) may include additional legs 214 for greater support. Additionally, because the angle theta of the inclined section 206 can only be increased a certain amount (e.g., a maximum theta) before there is risk of food product slipping, as the height H of the 208 increases, so does the overall length L (see e.g., FIG. 6) of the conveyor system 200. As the overall length L increases, the conveyor system 200 may include additional legs 214 as required to provide sufficient support for the conveyor system 200. It is recognized that while FIGS. 4-7 appear to illustrate the front end 210 positioned near or level with the ground 10, the front end 210 can be configured to be at any desired height to receive food product from an oven, depending on the length of the legs 214. For example, if an oven discharges food product at four feet, the front end 210 can be positioned at approximately four feet.

The support frame 201 may comprise any suitable material for supporting the conveyor system 200. In some examples, the support frame 201 comprises sheet metal. For example, the support frame 201 may comprise one or more of carbon steel, aluminum profile, stainless steel, negative steel, channel steel, and/or the like. In some examples, the support frame 201 may be formed by coupling multiple sheets of metal together. For example, the support frame 201 may include screw joints, rivet joint, clinching joints, welding joints, folding joints, sheet metal joints, adhesive bonding, and/or the like. In some examples, the support frame 201 may include one of more z-bends 218. For example, FIG. 4 illustrates a number of z-bends 218 in the first side member 202. The z-bends 218 may increase the strength and support provided by the support frame 201.

In some examples, the first side member 202 and/or the second side member 204 may include one or more openings 216. For example, FIG. 4 illustrates at least two openings 216 in the first side member 202. The openings 216 may comprise through holes extending through the respective side member 202/204. As shown in FIG. 4, a portion of the conveyor portions 300 are visible through the opening 216 of the first side member 202. The openings 216 may improve the cooling/equilibrating of food product on the conveyor system 200. For example, the openings 216 may allow or promote air flow over food product traveling on the conveyor portions 300. Further, because side members 202/204 contain heat generated by the food product, openings 216 promote heat exchange with the environment the conveyor system 200 is located in. Promoting heat exchange may be beneficial as it may reduce the required size of the conveyor system 200 or the number of conveyor portions 300 required. Opening 216 may provide further benefits in a climate controlled environment, such as an air conditioned room or section of a manufacturing facility. Opening 216 may also provide benefits related to visibility, maintenance, and cleaning. In other examples, the side members 202/204 may include more or less openings 216. In one example, the side members 202/204 may include no openings and may comprise solid walls. In some embodiments, the conveyor system 200 may be positioned in an environment with no additional cooling. In some embodiments, the conveyor system 200 may be positioned in a temperature controlled room.

As shown in FIG. 4, the conveyor system 200 may not include a cover or top portion that covers a top conveyor 310. As such, the top conveyor 310 carries food product that is generally exposed to the surrounding environment. The support frame 201 may include a top edge 220 that extends around all or a portion of the first side member 202 and the second side member 204. The top edge 220 may assist with containing food product on the top conveyor 310 during cooling/equilibrating. For example, food product that contacts the top edge 220 may be retained within the conveyor system 200 rather than falling off the side. The top edge 220 may also reduce the likelihood of injuries occurring related to the conveyor system 200. For example, there may be a gap between a side edge of the top conveyor 310 and an inside edge of the first/second side member 202/204. The gap may be a potential hazard as anything caught in the gap could be caught or impacted by the top conveyor 310. The top edge 220 may reduce the risk of anything getting caught in the gap.

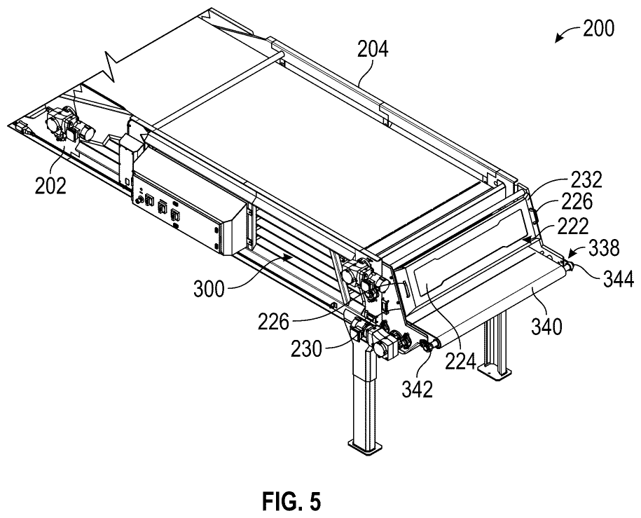

FIG. 5 illustrates a top, back, and right-side perspective view of the conveyor system 200 with certain component removed. As described above, food product is discharged from the conveyor system 200 via the back end 212. The back end 212 may include a panel 222. The panel 222 may comprise a viewing window 224 and one or more handles 226. The panel 222 may be coupled to the first side member 202 at a first side 230 and coupled to the second side member 204 at a second side 232. In some examples, the panel 222 may be removably coupled to the side members 202/204 by mechanical means such as, for example, screws, bolts, fasteners, and/or the like. In another example, the panel 222 may be coupled to the side members 202/204 via hinges or another mechanical system that allows an operator to move the panel 222 from a closed configuration to an open configuration, by, for example, pulling on the one or more handles 226. The panel 222 may allow an operator to view the inner workings of the conveyor system 200 either by removing the panel 222 or by the viewing window 224. The panel 222 may provide benefits of allowing the operator to identify and/or resolve issues with the conveyor system 200 without necessarily requiring disassembly of the conveyor system 200.

FIG. 5 further illustrates a discharge section 338 of a bottom conveyor portion 330. As shown, the discharge section 338 extends in a direction away from both the front end 210 and the back end 212 (e.g., the discharge portion 338 is distal to a proximal front end 210). Food product traveling along the conveyor portions 300 exits the conveyor system 200 via the discharge section 338. For example, food product exiting conveyor system 200 via the discharge section 338 may be transferred to another processing machine, such as another conveyor system for further processing. Further processing may include additional cooling, post cooling treatment, packaging, and/or the like. In some examples, including the example illustrated in FIGS. 5-8, the discharge section 338 may be supported by a discharge roller 340 at the distal end of the bottom conveyor portion 330. The discharge roller 340 may be rotatably coupled to the first side member 202 at a first end 342 and rotatably coupled to the second side member 204 at a second end 344. For example, the discharge roller 340 may freely rotate relative to the first and second side members 202/204 when the conveyor system 200 is in use.

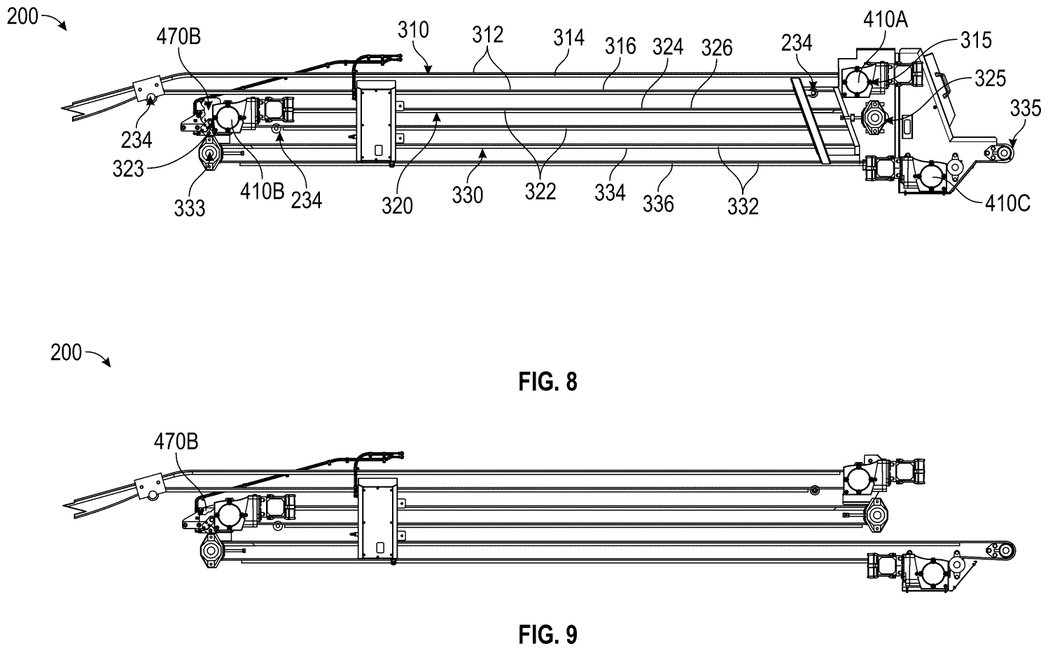

FIG. 6 illustrates a left-side view of the conveyor system 200 and FIG. 7 illustrates a right-side view of the conveyor system 200. As shown in FIG. 7, the conveyor system 200 includes a control system (not shown). The control system may include an electrical components housed in a control box 402. The control system is configured to control the electrical components of the conveyor system 200. For example, the control system controls a plurality of motors 410. In the example illustrated in FIGS. 4-15B, the plurality of motors 410 comprises three motors, a top/first motor 410A, a middle/second motor 410B, and a bottom/third motor 410C. However, it is recognized that the plurality of motors 410 can include any suitable number of motors. For example, the plurality of motors 410 may comprise 3, 5, 7, 9, 11, 13, 15, 17, 19, and/or the like motors 410. Generally, the number of motors 410 corresponds to the number of conveyor portions 300 in the conveyor system 200 because each individual motor 410 drives an individual conveyor portion 300. Use of individual motors 410 may provide certain benefits, such as, for example, the benefits described with reference to the individual motors 134 of the conveyor system 100. The motors 410 are described further with reference to FIGS. 8 and 9. The control system may further include one or more emergency shut offs. For example, the conveyor system 200 includes a right side pull cable 404A and a left side pull cable 404B. Both pull cables 404A/404B are connected to switches in the control system (e.g., housed in control box 402) that are configured to cause the conveyor system 200 to shut down when flipped (e.g., change states). For example, pulling on either pull cable 404A/404B sends a signal to the control system to cause the plurality of motors 410 to shut down. As shown in FIG. 6, the left side pull cable 404B is coupled to the second side member 204 and the right side pull cable 404A is coupled to the first side member 202. In other examples, the conveyor system 200 may include more or less pull cables 404A/404B and/or may include other emergency shut offs. In use, to stop the conveyor system 200, an operator may pull on either pull cable 404A/404B. Generally, there is sufficient tension in the pull cable 404A/404B to allow the switch to be easily triggered, but the pull cable 404A/404B are not so taut as to trigger false stops. In some examples, it may be preferable for the pull cable 404A/404B to extend along a majority of the side members 202/204. It may be of particular importance that there be an emergency shut off around areas of the support frame 201 that include openings 216.

FIGS. 8 and 9 illustrate a partial view of the conveyor system 200 with a majority of the support frame 201 removed. FIGS. 8 and 9 primarily illustrate the horizontal section 208 of the conveyor system 200. As discussed above, the conveyor system 200 includes a plurality of conveyor portions 300. The number of conveyor portions may depend on a number of factors, including: the type of food product, the temperature of the food product entering the conveyor system 200, the desired temperature of the food product exiting the conveyor system 200, the required time to cool/equalize the food product, the amount of space available for the conveyor system 200, and/or the like. For example, the conveyor system 200 may include 3, 5, 7, 9, 11, 13, 15, 17, 19, and/or the like conveyor portions 300. Generally, food product enters the conveyor system 200 via the front end 210 and exits on the opposite end via the back end 212. However, it may be desirable for food product to enter and exit the conveyor system 200 via the same side. In this example, the conveyor system 200 would include an even number of conveyor portions 300 instead of an odd number. In the example illustrated in FIGS. 4-15B, the conveyor system 200 includes a top/first conveyor portion 310, a middle/second conveyor portion 320, and a bottom/third conveyor portion 330. Each conveyor portion 300 comprises a continuous conveyor belt driven by a motor (e.g., the first motor 410A) on one end and extending between a motor assembly and a return roller (e.g., first return roller assembly 450A) on the opposite end.

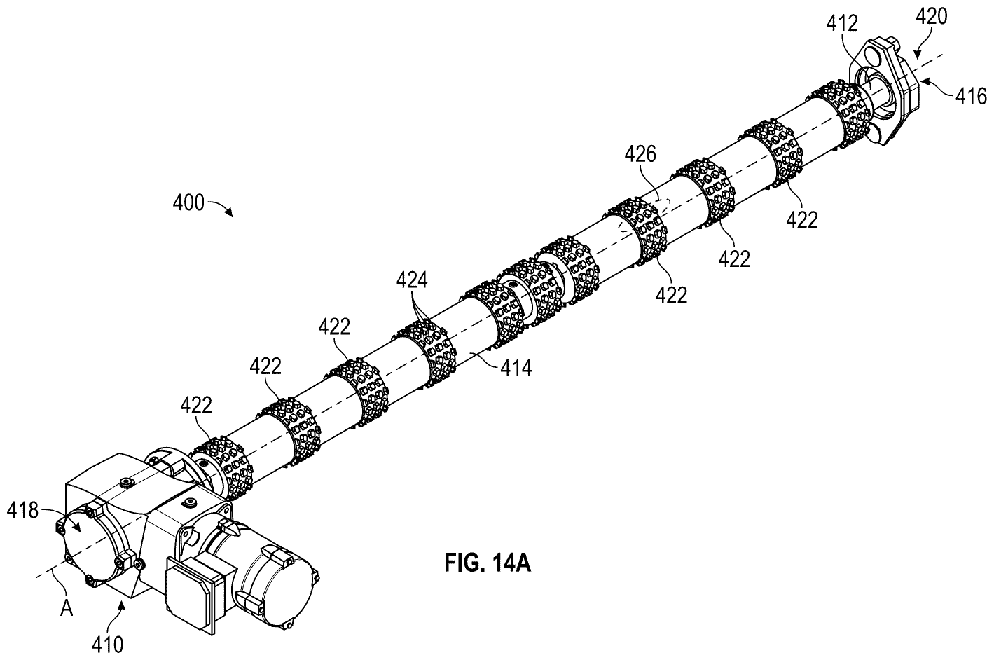

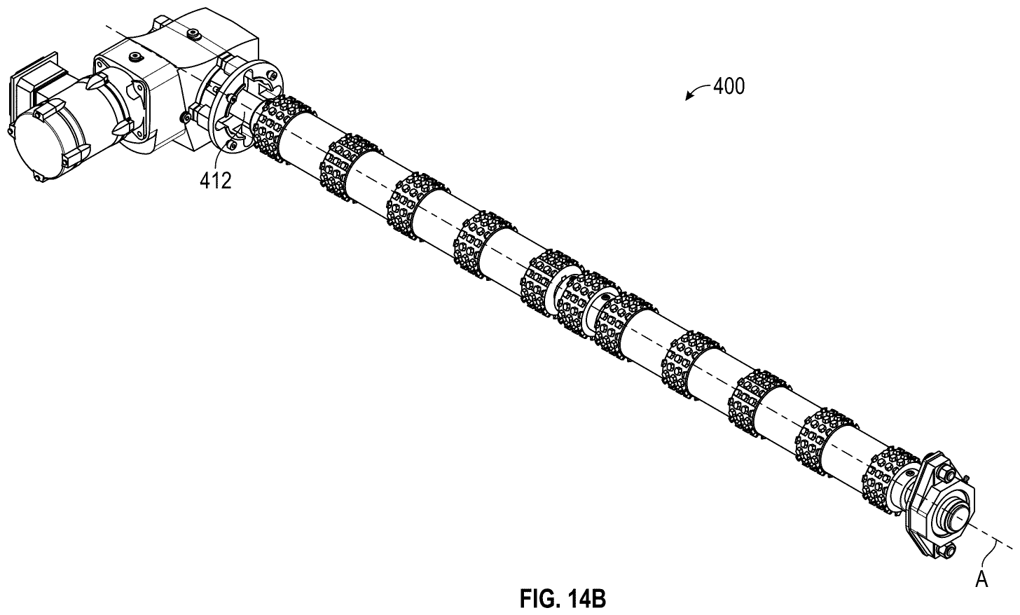

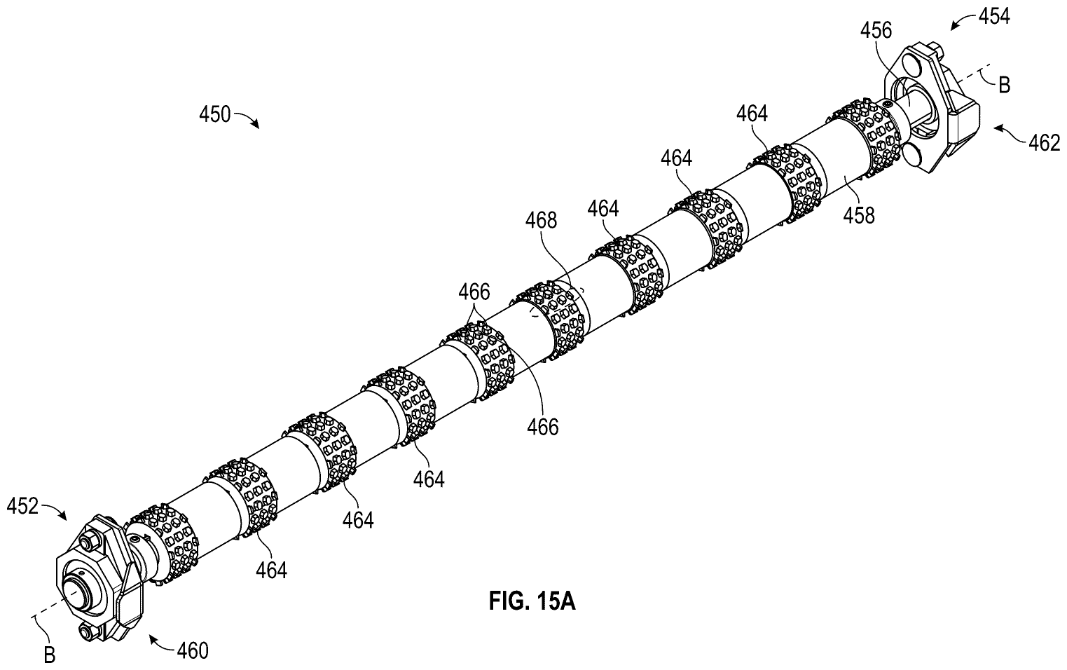

FIGS. 14A and 14B illustrate an example motor assembly 400. Motor assembly 400 is used as an example only and can correspond to any motor assembly (e.g., first motor assembly 400A, second motor assembly 400B, or third motor assembly 400C, etc.) in the conveyor system 200 or the conveyor system 100. The motor assembly 400 may comprise a motor 410, a drive shaft 412, a drive shaft jacket 414, and/or a bearing assembly 416. The motor 410 may be located at a first end 418 of the motor assembly 400 and may be coupled to the first side member 202 or the second side member 204. In the example illustrated herein, all motors 410 are positioned on the same side (i.e., the first side member 202) of the conveyor system 200. Having all motors 410 on the same side of the conveyor system 200 may provide benefits of more efficient cable management for the control system. The motors 410 may be coupled to the first side member 202 via any conventional mechanical means such as screws, bolts, fasteners, and/or the like. The motor 410 is configured to drive the drive shaft 412. The drive shaft 412 extends between the motor 410 at the first end 418 and the bearing assembly 416 at a second end 420. The drive shaft 412 may comprise a cylindrical rod. The bearing assembly 416 may be located at the second end 420 of the motor assembly 400 and may be coupled to the first side member 202 or the second side member 204. In the example illustrated herein, all bearing assembly 416 are positioned on the same side (i.e., the second side member 204) of the conveyor system 200. The bearing assembly 416 may be coupled to the second side member 204 via any conventional mechanical means such as screws, bolts, fasteners, and/or the like. The bearing assembly 416 is rotatably coupled to the drive shaft 412.

In the example illustrated in FIGS. 14A and 14B, the motor assembly 400 includes a drive shaft jacket 414 positioned on the drive shaft 412. The drive shaft jacket 414 may be coupled to and rotate with the drive shaft 412. For example, one rotation of the drive shaft 412 corresponds to one rotation of the drive shaft jacket 414. In some examples, the drive shaft 412 and the drive shaft jacket 414 may comprise two separate components, with the drive shaft 412 extending through the drive shaft jacket 414. In other examples, the drive shaft 412 and the drive shaft jacket 414 may be a unitary member. In some examples, the drive shaft 412 and the drive shaft jacket 414 may be removably coupled to each other. The drive shaft jacket 414 may include a plurality of engagement portions 422 positioned along the length of the drive shaft jacket 414 (i.e., between the first and second ends 418, 420) and extending circumferentially about the drive shaft jacket 414. Each engagement portion 422 may comprise a plurality of teeth 424. Each tooth 424 of the plurality of teeth 424 comprises a projection extending radially outward from the drive shaft jacket 414. The teeth 424 are configured to engage conveyor belts (e.g., first conveyor belt 312) of the conveyor portions 300. For example, as described further herein, the conveyor belts may include a plurality of holes which improve airflow and are shaped to receive the teeth 424. The teeth 424 may be arranged in rows 426 on the engagement portions 422. The rows 426 are perpendicular to the directions of travel of the conveyor portions 300 (e.g., described with reference to FIGS. 8 and 9) and parallel to the drive shaft 412. The shape of the teeth 424 corresponds to the shape of the holes in the conveyor belts of the conveyor portions 300. In the example illustrated in FIGS. 14A and 14B, the teeth 424 comprise a hexagonal shape. In other examples, the teeth 424 may comprise circular, ovular, rectangular, triangular, square, octagonal, and/or the like projections. In use, the motor 410 turns the drive shaft 412 and the drive shaft jacket 414 about an axis of rotation A. As the drive shaft jacket 414 rotates about the axis of rotation A, the teeth 424 engage the holes of conveyor belts, causing the conveyor belts to travel around the drive shaft 412, such that a top portion of the conveyor belt travels in a first direction and a bottom portion of the conveyor belt travels in a second direction opposite the first direction.

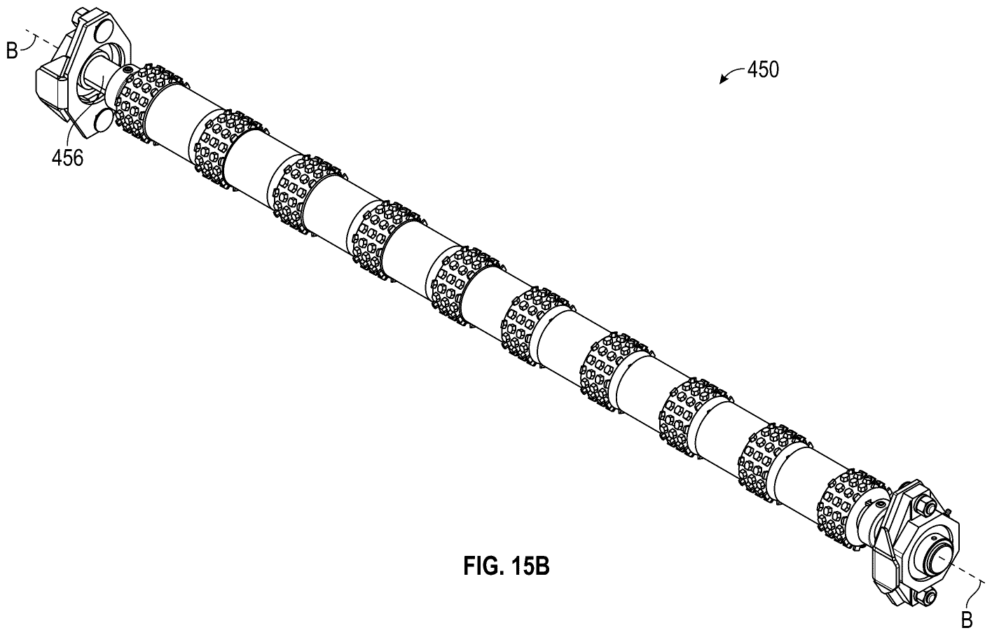

FIGS. 15A and 15B illustrate an example return roller assembly 450. A conveyor portion 300 may extend between and be supported by a return roller assembly 450 on one end and a motor assembly 400 on the opposite end. The return roller assemblies 450 are configured to rotate with the conveyor belts (e.g., the first conveyor belt 312) in use and provide support to the conveyor belts so that the top portions of the conveyor belts (e.g., the top side 314 of the first conveyor belt 312) are taut and do not sag or stretch under the weight of the food product. Return roller assembly 450 is used as an example only and can correspond to any return roller assembly (e.g., first return roller assembly 450A, second return roller assembly 450B, third return roller assembly 450C, etc.) in the conveyor system 200 or the conveyor system 100. The return roller assembly 450 may comprise a first roller bearing assembly 452, a second roller bearing assembly 454, a roller shaft 456, and/or a roller shaft jacket 458. The first roller bearing assembly 452 is located at a first end 460 of the roller shaft 456 and may be coupled to the first side member 202 or the second side member 204. In the example illustrated, the first roller bearing assembly 452 is coupled to the first side member 202. The first roller bearing assembly 452 may be coupled to the first side member 202 via any conventional mechanical means such as screws, bolts, fasteners, and/or the like. The first roller bearing assembly 452 is configured to receive the first end 460 of the roller shaft 456 and allow the roller shaft 456 to rotate about an axis of rotation B. The second roller bearing assembly 454 is located at a second end 462 of the roller shaft 456 and may be coupled to the first side member 202 or the second side member 204. In the example illustrated, the second roller bearing assembly 454 is coupled to the second side member 204. The second roller bearing assembly 454 may be coupled to the second side member 204 via any conventional mechanical means such as screws, bolts, fasteners, and/or the like. The second roller bearing assembly 454 is configured to receive the second end 462 of the roller shaft 456 and allow the roller shaft 456 to rotate about the axis of rotation B. Both the first roller bearing assembly 452 and the second roller bearing assembly 454 are rotatably coupled to the roller shaft 456.

The roller shaft 456 extends between the first roller bearing assembly 452 at the first end 460 and the second roller bearing assembly 454 at the second end 462. The roller shaft 456 may comprise a cylindrical rod. In the example illustrated in FIGS. 15A and 15B, the return roller assembly 450 includes a roller shaft jacket 458 positioned on the roller shaft 456. The roller shaft jacket 458 may be coupled to and rotate with the roller shaft 456. For example, one rotation of the roller shaft 456 corresponds to one rotation of the roller shaft jacket 458. In some examples, the roller shaft 456 and the roller shaft jacket 458 comprise two separate components, with the roller shaft 456 extending through the roller shaft jacket 458. In other examples, the roller shaft 456 and the roller shaft jacket 458 may be a unitary member. In some examples, the roller shaft 456 and the roller shaft jacket 458 may be removably coupled to each other. The roller shaft jacket 458 may include a plurality of engagement portions 464 positioned along the length of the roller shaft jacket 458 (i.e., between the first and second ends 460/462) and extending circumferentially about the roller shaft jacket 458. Each engagement portion 464 may comprise a plurality of teeth 466. Each tooth 466 of the plurality of teeth 466 comprises a projection extending radially outward from the roller shaft jacket 458. The teeth 466 are configured to engage conveyor belts (e.g., first conveyor belt 312) of the conveyor portions 300. For example, as noted above, the conveyor belts may include a plurality of holes which improve airflow and are shaped to receive the teeth 466. The teeth 466 may be arranged in rows 468 on the engagement portions 464. The rows 468 are perpendicular to the directions of travel of the conveyor portions 300 (e.g., described with reference to FIGS. 8 and 9) and parallel to the roller shaft 456. The shape of the teeth 466 corresponds to the shape of the holes in the conveyor belts of the conveyor portions 300. In the example illustrated in FIGS. 15A and 15B, the teeth 466 comprise a hexagonal shape. In other examples, the teeth 466 may comprise circular, ovular, rectangular, triangular, square, octagonal, and/or the like projections. In use, the return roller assembly 450 is aligned with the motor assembly 400 with a conveyor portion 300 extending between the return roller assembly 450 and the motor assembly 400. The axis of rotation A and the axis of rotation B are parallel to each other, the first end 418 of the drive shaft 412 is generally aligned along the same yz-plane as the first end 460 of the roller shaft 456, and the second end 420 of the drive shaft 412 is generally aligned along the same yz-plane as the second end 462 of the roller shaft 456. Here, the z-direction extends vertically from the ground 10, the y-direction extends along a line moving from the front end 210 to the back end 212, and the x-direction is perpendicular to the y-direction (i.e., extends between the first side member 202 and the second side member 204). As the drive shaft jacket 414 rotates about axis of rotation A, the teeth 424 engage the holes of conveyor belts, causing the conveyor belts to travel around the drive shaft 412, such that a top portion of the conveyor belt travels in the first direction and a bottom portion of the conveyor belt travels in the second direction opposite the first direction. As the conveyor belt is driven, the holes of the conveyor belt engage the teeth 466 of the roller shaft jacket 458, causing both the roller shaft jacket 458 and the roller shaft 456 to rotate about the axis of rotation B.

The conveyor system 200 may comprise additional rollers positioned between the motor assemblies 400 and return roller assemblies 450 of the conveyor portions 300. The additional rollers may provide additional support to the conveyor belts and may be coupled to the first side member 202 and the second side member 204. For example, FIG. 8 illustrates some example additional rollers 234.

With continued reference to the example illustrated in FIGS. 8 and 9, the conveyor system 200 includes the top/first conveyor portion 310, the middle/second conveyor portion 320, and the bottom/third conveyor portion 330. The top conveyor portion 310 comprises a first conveyor belt 312. The first conveyor belt 312 is a continuous conveyor belt extending between the first motor assembly 400A and the first return roller assembly 450A (e.g., see FIG. 7). Continuous, as the term is used here, refers to fact that the first conveyor belt 312 is a single unit (i.e., does not include multiple belt portions). The first conveyor belt 312 comprises a first end 313, a second end 315, a top side 314, and a bottom side 316. The first end 313 is defined as the proximal most portion (i.e., the portion closest to the front end 210) of the first conveyor belt 312 at any given time. Similarly, the second end 315 is defined as the distal most portion (i.e., the portion farthest from the front end 210) of the first conveyor belt 312 at any given time. The top side 314 is defined as the portion of the first conveyor belt 312 that travels in the first direction (i.e., the proximal to distal direction, from left to right in FIGS. 8 and 9) in use. The top side 314 is configured to carry food product in the first direction. The bottom side 316 is defined as the portion of the first conveyor belt 312 that travels in the second direction (i.e., the distal to proximal direction, from right to left in FIGS. 8 and 9) in use. It is recognized that when the conveyor system 200 is in use and the first conveyor belt 312 is continually moving, the specific portion of the first conveyor belt 312 that is the first end 313, the top side 314, the second end 315, and the bottom side 316 is continually changing.

The first conveyor belt 312 extends between and is supported by the first motor assembly 400A and the first return roller assembly 450A, such that the first conveyor belt 312 extends along both the inclined section 206 and the horizontal section 208. Therefore, the first conveyor belt 312 is configured to transport food product along the inclined section 206 and the horizontal section 208. Generally, the first conveyor belt 312 is configured such that the top side 314 is taut and does not sag or stretch under the weight of the food product. In used, a first drive shaft 412A of the first motor assembly 400A is driven by a first motor 410A. As explained with reference to FIGS. 14A-15B, rotation of the first drive shaft 412A results in the first plurality of teeth 424A of the first engagement portions 422A engaging the holes (not shown) of the first conveyor belt 312. Continued rotation of the first drive shaft 412A causes the top side 314 to travel in the first direction and the bottom side 316 to travel in the second direction. As the first drive shaft 412A rotates and drives the first conveyor belt 312, the holes of the first conveyor belt 312 engage the first teeth 466A of the first engagement portions 464A, causing the first return roller assembly 450A to rotate about its axis.

The second conveyor portion 320 comprises a second conveyor belt 322. The second conveyor belt 322 is a continuous conveyor belt extending between the second motor assembly 400B and the second return roller assembly 450B. The second conveyor belt 322 comprises a first end 323, a second end 325, a top side 324, and a bottom side 326. The first end 323 is defined as the proximal most portion (i.e., the portion closest to the front end 210) of the second conveyor belt 322 at any given time. Similarly, the second end 325 is defined as the distal most portion (i.e., the portion farthest from the front end 210) of the second conveyor belt 322 at any given time. The top side 324 is defined as the portion of the second conveyor belt 322 that travels in the second direction. The top side 314 is configured to carry food product in the second direction in use. The bottom side 326 is defined as the portion of the second conveyor belt 322 that travels in the first direction in use. It is recognized that when the conveyor system 200 is in use and the second conveyor belt 322 is continually moving, the specific portion of the second conveyor belt 322 that is the first end 323, the top side 324, the second end 325, and the bottom side 326 is continually changing.

The second conveyor belt 322 extends between and is supported by the second motor assembly 400B and the second return roller assembly 450B, such that the second conveyor belt 322 extends along at least the horizontal section 208. Unlike the first conveyor belt 312, the second conveyor belt 322 does not include an inclined portion and the second conveyor belt 322 is configured to transport food product along the horizontal section 208. Generally, the second conveyor belt 322 is configured such that the top side 324 is taut and does not sag or stretch under the weight of the food product. In used, a second drive shaft 412B of the second motor assembly 400B is driven by a second motor 410B. As explained with reference to FIGS. 14A-15B, rotation of the second drive shaft 412B results in the second plurality of teeth 424B of the second engagement portions 422B engaging the holes (not shown) of the second conveyor belt 322. Continued rotation of the second drive shaft 412B causes the top side 324 to travel in the second direction and the bottom side 326 to travel in the first direction. As the second drive shaft 412B rotates and drives the second conveyor belt 322, the holes of the second conveyor belt 322 engage the first teeth 466B of the first engagement portions 464B, causing the second return roller assembly 450B to rotate about its axis. As shown in FIGS. 8 and 9, the axis of the second drive shaft 412B and the axis of the second roller shaft 456B are aligned on the same xy-plane.

The bottom conveyor portion 330 comprises a third conveyor belt 332. In the example illustrated, the third conveyor belt 332 is a continuous conveyor belt extending between the third return roller assembly 450C and the discharge roller 340. The third conveyor belt 332 comprises a first end 333, a second end 335, a top side 334, and a bottom side 336. The first end 333 is defined as the proximal most portion (i.e., the portion closest to the front end 210) of the third conveyor belt 332 at any given time. Similarly, the second end 335 is defined as the distal most portion (i.e., the portion farthest from the front end 210) of the third conveyor belt 332 at any given time. The top side 334 is defined as the portion of the third conveyor belt 332 that travels in the first direction) in use. The top side 334 is configured to carry food product in the first direction. The bottom side 336 is defined as the portion of the third conveyor belt 332 that travels in the second direction in use. It is recognized that when the conveyor system 200 is in use and the third conveyor belt 332 is continually moving, the specific portion of the third conveyor belt 332 that is the first end 333, the top side 334, the second end 335, and the bottom side 336 is continually changing.

The third conveyor belt 332 extends between and is supported by the third return roller assembly 450C and the discharge roller 340, such that the third conveyor belt 332 extends along at least the horizontal section 208. Unlike the first conveyor belt 312, the third conveyor belt 332 does not include an inclined portion and the third conveyor belt 332 is configured to transport food product along the horizontal section 208. Generally, the third conveyor belt 332 is configured such that the top side 334 is taut and does not sag or stretch under the weight of the food product. In used, a third drive shaft 412C of the third motor assembly 400C is driven by a third motor 410C. As explained with reference to FIGS. 14A-15B, rotation of the third drive shaft 412C results in the third plurality of teeth 424C of the third engagement portions 422C engaging the holes (not shown) of the third conveyor belt 332. Continued rotation of the third drive shaft 412C causes the top side 334 to travel in the first direction and the bottom side 336 to travel in the second direction. As the third drive shaft 412C rotates and drives the third conveyor belt 332, the holes of the third conveyor belt 332 engage the third teeth 466C of the third engagement portions 464C, causing the third return roller assembly 450C to rotate about its axis. Unlike the second conveyor portion 320, in the example illustrated, the axis of the third drive shaft 412C and the axis of the third roller shaft 456C are not aligned on the same xy-plane. Rather, an axis of the discharge roller 340 and the axis of the third roller shaft 456C are aligned on the same xy-plane. This configuration allows the bottom conveyor portion 330 to include the discharge section 338. In the example illustrated, the axis of the third drive shaft 412C is positioned on an xy-plane that is closer to the ground 10 than the xy-plane of the discharge roller 340 and third roller shaft 456C axes.

The conveyor belts described herein (e.g., first conveyor belt 312, second conveyor belt 322, third conveyor belt 332, and/or the like) may comprises any suitable material. For example, the conveyor belts may comprise one or more of: thermoplastics, metal, rubber, and/or the like. In some examples, the conveyor belts may comprise modular belts with a plurality of openings/holes. For example, the conveyor belts may comprise a mesh structure. The size of the holes may vary between different embodiments of the conveyor system 200. For example, the hole size may depend on the type of product being cooled/equalized. While the holes provide benefits for driving the conveyor belts, as described herein, the holes also provide air exposure to food product traveling on the conveyor system 200.

In operation, each of the first, second, and third motor assemblies 400A, 400B, 400C, are configured to drive their respective conveyor belts 312, 322, 332 at the same time. The motor assemblies 400A, 400B, 400C may be configured to drive the conveyor belts 312, 322, 332 are variable speeds. For example, each conveyor belt 312, 322, 332 may be driven at a range of speeds. The speed of each conveyor belt 312, 322, 332 may depend on a number of factors, including: the type of food product, the number of conveyor portions 300, the temperature of the food product entering the conveyor system 200, the desired temperature of the food product exiting the conveyor system 200, the required time to cool/equalize the food product, and/or the like. In operation, the first motor assembly 400A drives the first conveyor belt 312 such that the top side 314 travels in the first direction at a first speed, the second motor assembly 400B drives the second conveyor belt 322 such that the top side 324 travels in the second direction at a second speed, and the third motor assembly 400C drives the third conveyor belt 332 such that the top side 334 travels in the first direction at a third speed. In some examples, one or all of the first, second, and third speed may be the same. In other examples, one or all of the first, second, and third speed may vary. For example, it may be desirable for the second speed to be greater than the first speed and the third speed be greater than the first speed and/or the second speed. Increasing the speed of each conveyor portion 300 moving from top to bottom may provide benefits such as preventing damage to the food product traveling on the on the conveyor system 200. For example, if the food product is traveling as a speed greater than the speed of the conveyor belt the food product is being transferred to, there may be damage to the food product.

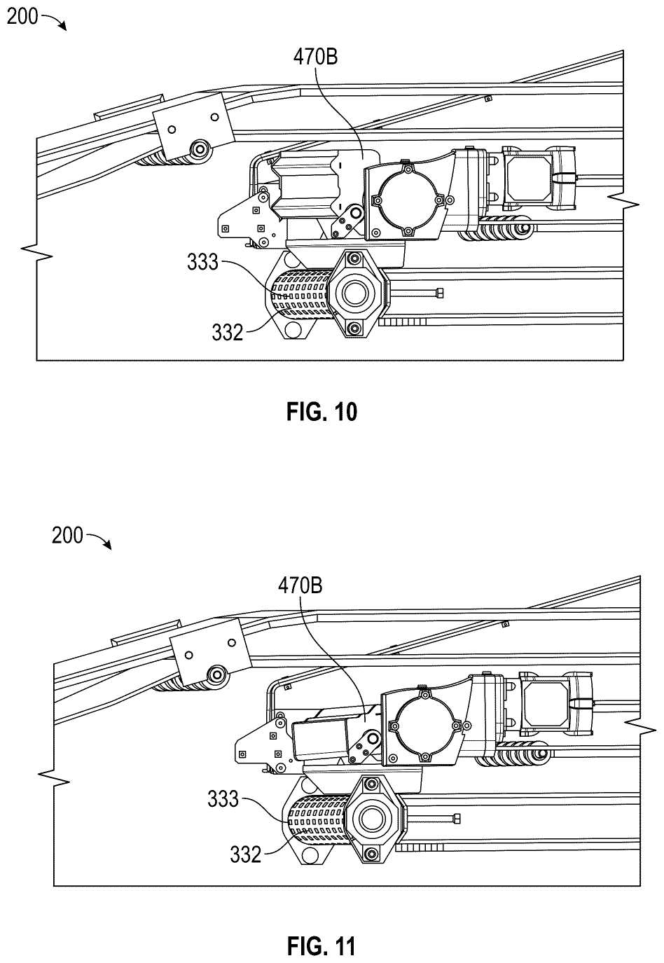

In use, food product enters the conveyor system 200 via the front end 210 and begins traveling along the first conveyor belt 312 in the first direction. The food product travels in the first direction over both the inclined section 206 and horizontal section 208 on the first conveyor belt 312. As the food product reaches the second end 315 of the first conveyor belt 312, the first conveyor belt 312 causes the food product to contact a transfer member 470 (e.g., first transfer member 470A), which transfers the food product to the second conveyor belt 322. The transfer members 470 are described in greater detail with respect to FIGS. 10-13. After exiting the first transfer member 470A, the food product begins traveling on the second conveyor belt 322 near the second end 325 in the second direction. As the food product reaches the first end 323 of the second conveyor belt 322, the second conveyor belt 322 causes the food product to contact another transfer member 470 (e.g., second transfer member 470B), which transfers the food product to the third conveyor belt 332. After exiting the second transfer member 470B, the food product begins traveling on the third conveyor belt 332 near the first end 333 in the first direction. The food products continues traveling along the third conveyor belt 332 until the food product reaches the discharge section 338. At this point, the food product exits the conveyor portions 300.

While the example conveyor system 200 illustrated in FIGS. 4-15B include three conveyor portions 300, in other examples, the conveyor system 200 could include one or more additional conveyor portions 300 as noted above. Generally, the additional conveyor portions 300 could comprise additional middle conveyor portions, similar to the second conveyor portion 320. For example, a conveyor system could include a top conveyor portion 310 and a bottom conveyor portion 330, and any number of additional middle conveyor portions 320 between the top and bottom conveyor portions 310, 330. However, the number of additional middle conveyor portions 320 will typically be an odd number. For example, in some embodiments, the conveyor system 200 may include five conveyor portions 300. In this example, food product travels on the top conveyor portion 310 in the first direction, is transferred to a first middle conveyor portion 320A via a transfer member 470, to travel in the second direction. Next, the food product travels the length of the first middle conveyor portion 320A and is then transferred to a second middle conveyor portion 320B via a transfer member 470, to travel in the first direction. Next, the food product travels the length of the second middle conveyor portion 320B and is then transferred to a third middle conveyor portion 320C via a transfer member 470, to travel in the second direction. Next, the food product travels the length of the third middle conveyor portion 320C and is then transferred to the bottom conveyor portion 330 via a transfer member 470, to travel in the first direction. Finally, the food product travels the length of the bottom conveyor portion 330 and is discharged from the conveyor system 200 via the discharge section 338. The foregoing example is just one example of a conveyor system 200 that includes additional middle conveyor portions 320. It is recognized that any number of additional middle conveyor portions 320 to the conveyor system 200.

One benefit of the conveyor system 200 is the option to extend the middle conveyor portions 320 and the bottom conveyor portion 330 under the inclined portion of the top conveyor 310. In the example illustrated in FIGS. 4-15B, the middle and bottom conveyor portions 320, 330 extend approximately to the interface of the inclined section 206 and the horizontal section 208. However, it is recognized that the first end 323 of the middle conveyor portion 320 and the first end 333 of the bottom conveyor portion 330 could extend further in the proximal direction to be underneath the inclined section 206. By positioning the middle and bottom conveyor portions 320, 330 underneath the inclined section 206, the space underneath the inclined section 206 can be more efficiently utilized. For example, as noted above, in a traditional system, the space under the boom (inclined section 206) is not utilized for additional cooling/equilibrating. However, as the middle and bottom conveyor portions 320, 330 begin to extend under the inclined section 206, additional cooling/equilibrating benefits can be recognized without taking up any additional floor space. This benefit is further realized by the addition of more middle conveyor portions 320. For example, as noted above, the angle theta generally remains consistent, even as the number of conveyor portions 300 increases. As such, taller conveyor systems 200 (i.e., with more conveyor portions 300) include more wasted space. However, each additional middle conveyor portions 320 can extend further in the proximal direction under the inclined section 206, without interfering with the top conveyor portion 310. The further the middle conveyor portions 320 extend under the inclined section 206, the greater the cooling/equilibrating benefits. It is recognized that as the additional middle conveyor portions 320 extend further under the inclined section 206, so does the bottom conveyor portion 330.

FIG. 10 illustrates a close up section view of the first ends 323, 333, of the second and third conveyor belts 322, 332 as shown in FIG. 8. FIG. 11 illustrates a close up section view of the first ends 323, 333, of the second and third conveyor belts 322, 332 as shown in FIG. 9. In FIGS. 8 and 10, the second transfer member 470B is in a first/closed configuration, in FIGS. 9 and 11, the second transfer member 470B in in a second/open configuration.

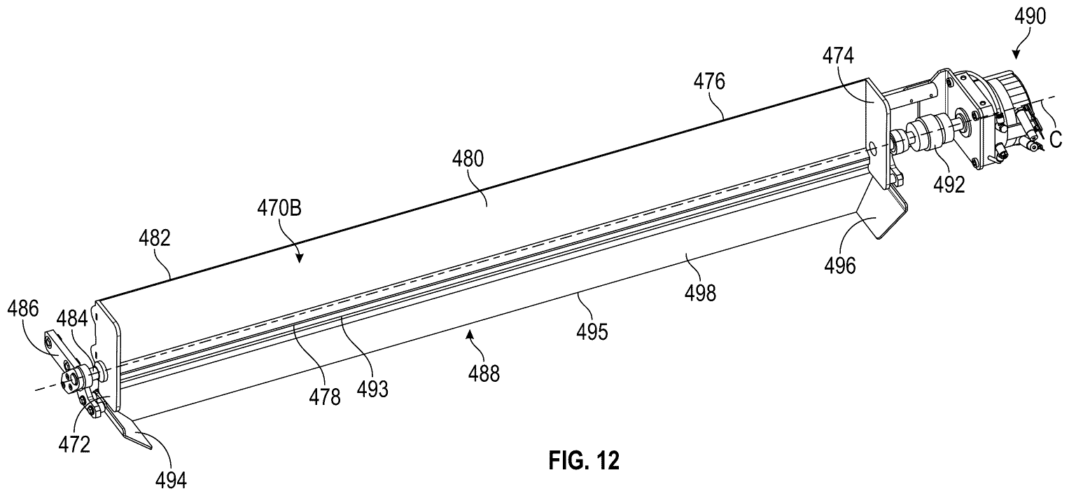

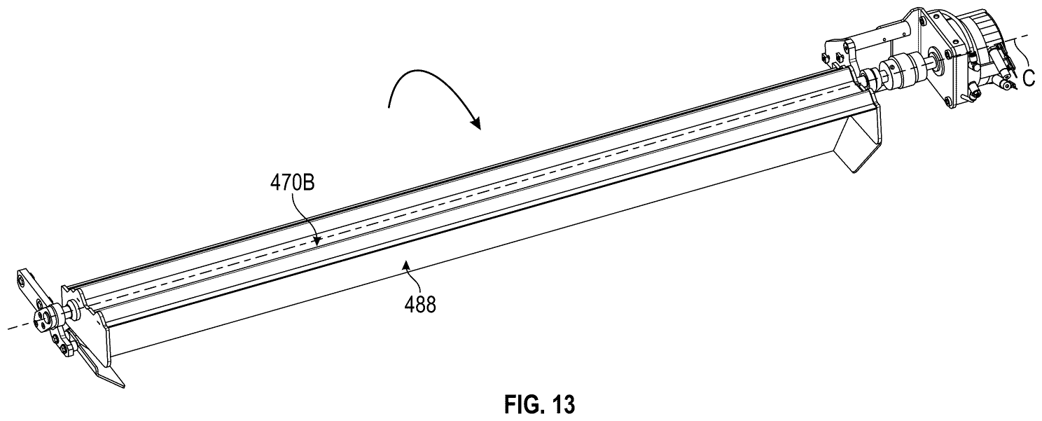

FIG. 12 illustrates an isolation view of the second or reject transfer member 470B in the closed configuration and FIG. 13 illustrates an isolation view of the reject transfer member 470B in the open configuration. As described above, each transfer member 470 (including the reject transfer member 470B) is configured to transfer food product from one conveyor portion to another (e.g., from the second conveyor portion 320 to the third conveyor portion 330). However, in some examples, the conveyor system 200 may include a reject transfer member, such as the second transfer member 470B, that serves a dual function of transferring food product in a closed configuration and allowing rejected food product to be rejected/ejected from the conveyor system 200 in an open configuration. Other transfer members 470 may comprises the same or similar structures as the reject transfer member 470B, however, the other transfer members 470 may not move between an open and closed configuration and may instead be stationary. In some embodiments, the conveyor system 200 may include more than one reject transfer member 470B.

The reject transfer member 470B may comprise a first side 472, a second side 474, a top edge 476, a bottom edge 478, an inside surface 480, and an outside surface 482. The first side 472 may comprise a plate extending from the outside surface 482 in a direction towards and past the inside surface 480. The first side 472 may be connected to the top edge 476 and the bottom edge 478. Similarly, the second side 474 may comprise a plate extending from the outside surface 482 in a direction towards and past the inside surface 480. The second side 474 may be connected to the top edge 476 and the bottom edge 478.

The first side 472 may be rotationally coupled to one of the first side member 202 or the second side member 204. In the example illustrated, the first side 472 is coupled to a transfer shaft 484. The transfer shaft 484 is rotationally coupled to a bracket assembly 486, which in turn is coupled to the first side member 202. As a result of this configuration, the reject transfer member 470B can rotate about an axis of rotation C relative to the first side member 202. The second side 474 is coupled to a shaft assembly 492 of a transfer motor 490 along the axis of rotation C. In the example illustrated, the transfer motor 490 is coupled to the second side member 204 and is configured to cause the reject transfer member 470B to rotate about the axis of rotation C. For example, the transfer motor 490 is configured to rotate the reject transfer member 470B from the closed configuration, as shown in FIGS. 10 and 12, to the open configuration, as shown in FIGS. 11 and 13. The transfer motor 490 may be controlled by the control system or may be controlled by a separate control system. In some examples, the transfer motor 490 may comprise a pneumatic motor. For example, the transfer motor 490 may have a pressure regular and an air supply, which may improve the compactness of the transfer motor 490 and the ease of operation.

In the conveyor system 200, the reject transfer member 470B may be positioned above a receiver member 488. The receiver member 488 is configured to assist the reject transfer member 470B in transferring the food product between conveyor portions 300. The receiver member 488 may comprise a first side 494, a second side 496, and a back plate 498 comprising a top edge 493 and a bottom edge 495. The back plate 498 may be sloped in the direction of movement (i.e., the first direction or the second direction) towards the conveyor portion the reject transfer member 470B is directing the food product to. For example, as illustrated, the back plate 498 is sloped from the top edge 493 to the bottom edge 495 in the proximal to distal direction because the bottom conveyor portion 330 is traveling in the first direction. The first side 494 and the second side 496 may be sloped inwardly and towards each other. For example, the first side 494 may be sloped inwardly from the first side member 202 and the second side 496 may be sloped inwardly from the second side member 204.

In use, food product traveling from the second conveyor portion 320 contacts the reject transfer member 470B on the inside surface 480, moves in a downward direction to contact the receiver member 488, and is delivered to the bottom conveyor portion 330. Generally, the food product is rotated 180 degrees during the transfer between conveyor portions. For example, a bottom side of a food product may be supported by the second conveyor belt 322 prior to being transferred to the third conveyor belt 332. After being transferred via the reject transfer member 470B and the receiver member 488, the food product may be traveling with a top side supported by the third conveyor belt 332.

In some examples, the bottom edge 478 of the reject transfer member 470B may be configured to be in contact with an aligned with the top edge 493 of the receiver member 488 in the closed configuration. In other examples, a small gap may exist between the bottom edge 478 and the top edge 493 in the closed configuration. The reject transfer member 470B and the receiver member 488 may comprise any suitable material. For example, the reject transfer member 470B and the receiver member 488 may comprise a metal, a plastic, and/or the like.

Under normal operations, the reject transfer member 470B is generally in the closed configuration. However, the reject transfer member 470B may be rotated to the open condition via the transfer motor 490 when an operator wishes to discard food product without allowing the food product to travel to the discharge section 338. For example, if there is damaged or undesirable food product traveling on the conveyor system 200, an operator can move the reject transfer member 470B to the open configuration and the food product will travel along the second conveyor belt 322 until the food product reaches the first end 323 of the second conveyor belt 322. At this point, the food product will not encounter the reject transfer member 470B or the receiver member 488 and the velocity of the food product will allow the food product to be rejected from the conveyor system 200. A waste collection bin may be positioned under the inclined section 206 to received rejected food product. Being able to reject food by opening the reject transfer member 470B may provide benefits of not requiring food product designated for waste to travel the entire conveyor system 200. For example, in other systems, waste food product may be separated from quality food product after exiting conveyor system. This type of system may require sorting at the discharge section 338.

The conveyor system 200 includes a plurality of transfer member 470. Generally, the plurality of transfer member 470 comprises one less than the number of conveyor portions 300 in the conveyor system 200. In the example illustrated, the conveyor system 200 includes three conveyor portions 300 and two transfer members 470A, 470B. In another example, if the conveyor system 200 comprised five conveyor portions 300, then the conveyor system 200 would include four transfer members 470. Each transfer member 470 may be similar or identical to the reject transfer member 470B described above. However, it may not be desirable for every transfer member 470 to be configured to rotate between opened and closed configurations. Generally, a conveyor system 200 may only include one transfer member 470 that can be used to reject waste food products. The other transfer members, such as first transfer member 470A may comprise the same components as reject transfer member 470B, with the exception of the transfer shaft 484, transfer motor 490, and shaft assembly 492. Instead, the first transfer member 470A may be coupled to the first side member 202 and the second side member 204 on its first and second sides. Additionally, the first transfer member 470A may include a first receiver member 488A and may be a single unit. For example, a top edge 476A of the first transfer member 470A would be joined to a top edge 493 of the first receiver member 488A such that the first transfer member 470A and the first receiver member 488A comprise a single unit. The word “joined” is used for illustrative purposes. In some examples, the first transfer member 470A may be manufactured to include both the first transfer member 470A and the first receiver member 488A as a unitary member.

### Additional Embodiments

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include these features, elements and/or states.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

While the above detailed description may have shown, described, and pointed out novel features as applied to various embodiments, it may be understood that various omissions, substitutions, and/or changes in the form and details of any particular embodiment may be made without departing from the spirit of the disclosure. As may be recognized, certain embodiments may be embodied within a form that does not provide all of the features and benefits set forth herein, as some features may be used or practiced separately from others.

Additionally, features described in connection with one embodiment can be incorporated into another of the disclosed embodiments, even if not expressly discussed herein, and embodiments having the combination of features still fall within the scope of the disclosure. For example, features described above in connection with one embodiment can be used with a different embodiment described herein and the combination still fall within the scope of the disclosure.

It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this disclosure may comprise, additional to its essential features described herein, one or more features as described herein from each other embodiment disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added.

Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Reference to any prior art in this description is not, and should not be taken as, an acknowledgement or any form of suggestion that that prior art forms part of the common general knowledge in the field of endeavor in any country in the world.

The invention may also be said broadly to consist in the parts, elements and features referred to or indicated in the description of the application, individually or collectively, in any or all combinations of two or more of said parts, elements or features.

Where, in the foregoing description, reference has been made to integers or components having known equivalents thereof, those integers are herein incorporated as if individually set forth. In addition, where the term “substantially” or any of its variants have been used as a word of approximation adjacent to a numerical value or range, it is intended to provide sufficient flexibility in the adjacent numerical value or range that encompasses standard manufacturing tolerances and/or rounding to the next significant figure, whichever is greater.

It should be noted that various changes and modifications to the presently preferred embodiments described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present invention. Accordingly, the scope of the present invention is intended to be defined only by the claims.

What is claimed is:

1. A conveyor system comprising:
a support frame comprising a first side member and a second side member, the first and second side members comprising an inclined section and a horizontal section;
a top conveyor portion extending along the inclined section and the horizontal section, the top conveyor portion comprising a top conveyor belt supported by a top return roller, the top return roller extending between the first side member and the second side member, the top conveyor portion driven by a top motor;
a middle conveyor portion positioned below the top conveyor portion, the middle conveyor portion comprising a middle conveyor belt supported by a middle return roller, the middle return roller extending between the first side member and the second side member, the middle conveyor portion driven by a middle motor; and
a bottom conveyor portion positioned below the middle conveyor portion, the bottom conveyor portion comprising a bottom conveyor belt supported by a bottom return roller, the bottom return roller extending between the first side member and the second side member, the bottom conveyor portion driven by a bottom motor.

2. The conveyor system of claim 1, further comprising a plurality of legs, the first side member and the second side member supported by the plurality of legs.

3. The conveyor system of claim 1, wherein the top conveyor belt and the bottom conveyor belt are configured to travel in a first direction and the middle conveyor belt is configured to travel in a second direction, the first direction opposite the second direction.

4. The conveyor system of claim 1, further comprising a first transfer member and a second transfer member, the first transfer member configured to transport food product from the top conveyor belt to the middle conveyor belt, the second transfer member configured to transport food product from the middle conveyor belt to the bottom conveyor belt.

5. The conveyor system of claim 4, wherein the second transfer member is configured to move between a first configuration and a second configuration, wherein in the first configuration, the second transfer member is configured to transport food product from the middle conveyor belt to the bottom conveyor belt, wherein in the second configuration, the second transfer member is configured to allow food product to be rejected from the conveyor system.

6. The conveyor system of claim 5, wherein a transfer motor is configured to move the second transfer member from the first configuration to the second configuration.

7. The conveyor system of claim 1, wherein the top conveyor belt is configured to travel at a first speed, the middle conveyor belt is configured to travel at a second speed, and the bottom conveyor belt is configured to travel at a third speed in use, the second speed greater than the first speed, the third speed greater than the second speed.

8. The conveyor system of claim 1, wherein at least one of the first side member and the second side member comprise one or more side openings.

9. The conveyor system of claim 1, wherein the top conveyor belt, the middle conveyor belt, and the bottom conveyor belt comprise a mesh structure with a plurality of openings.

10. The conveyor system of claim 1, wherein at least one of the top motor, the middle motor, or the bottom motor are configured to run at variable speeds.

11. The conveyor system of claim 1, wherein at least one of the middle conveyor portion or the bottom conveyor portion extends below an inclined portion of the top conveyor portion.

12. The conveyor system of claim 1, further comprising a plurality of conveyor portions positioned below the middle conveyor portion, each conveyor portion of the plurality of conveyor portions comprising a conveyor belt supported by a return roller extending between the first side member and the second side member.

13. A conveyor system comprising:
a support frame comprising a first side member and a second side member, the first and second side members comprising an inclined section and a horizontal section;
a first conveyor portion comprising a first conveyor belt supported by a first return roller, the first return roller extending between the first side member and the second side member, the first conveyor portion driven by a first motor assembly;
a second conveyor portion positioned below the first conveyor portion, the second conveyor portion comprising a second conveyor belt supported by a second return roller, the second return roller extending between the first side member and the second side member, the second conveyor portion driven by a second motor assembly, the second motor assembly extending between the first side member and the second side member in the inclined section, such that a portion of the second conveyor belt extends into the inclined section; and
a third conveyor portion positioned below the second conveyor portion, the third conveyor portion comprising a third conveyor belt supported by a third return roller, the third return roller extending between the first side member and the second side member, the third conveyor portion driven by a third motor assembly, the third motor assembly extending between the first side member and the second side member in the inclined section, such that a portion of the third conveyor belt extends into the inclined section.

14. The conveyor system of claim 13, wherein the first conveyor belt and the third conveyor belt are configured to travel in a first direction and the second conveyor belt is configured to travel in a second direction, the first direction opposite the second direction.

15. The conveyor system of claim 13, wherein at least one of the first side member and the second side member comprise one or more side openings.

16. The conveyor system of claim 13, further comprising a first transfer member and a second transfer member, the first transfer member configured to transport food product from the first conveyor belt to the second conveyor belt, the second transfer member configured to transport food product from the second conveyor belt to the third conveyor belt.

17. A conveyor system comprising:
a support frame comprising a first side member and a second side member;
a first conveyor portion comprising a first conveyor belt extending between a first return roller and a first motor assembly, the first return roller and the first motor assembly extending between the first side member and the second side member;
a second conveyor portion comprising a second conveyor belt extending between a second return roller and a second motor assembly, the second return roller and the second motor assembly extending between the first side member and the second side member;
a third conveyor portion comprising a third conveyor belt extending between a third return roller and a third motor assembly, the third return roller and the third motor assembly extending between the first side member and the second side member; and
a transfer member extending between the first side member and the second side member, the transfer member configured to transfer food product from the second conveyor belt to the third conveyor belt when in a closed configuration, the transfer member configured to rotate to an open configuration, wherein the open configuration, food product is ejected from the conveyor system.

18. The conveyor system of claim 17, wherein the first conveyor belt and the third conveyor belt are configured to travel in a first direction and the second conveyor belt is configured to travel in a second direction, the first direction opposite the second direction.

19. The conveyor system of claim 17, wherein at least one of the first side member and the second side member comprise one or more side openings.

20. The conveyor system of claim 17, wherein a transfer motor is configured to move the transfer member from the closed configuration to the open configuration.
